(19) United States
(12) Patent Application Publication
(10) Pub. No.: US 2026/0239425 A1
(43) Pub. Date: Aug. 13, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Yajun CHENG, Beijing (CN)

(73) Assignee: Beijing Xiaomi Mobile Software Co., Ltd., Beijing (CN)

(21) Appl. No.: 19/469,593

(22) PCT Filed: Mar. 30, 2023
(86) PCT No.: PCT/CN2023/085192

§ 371 Date: Sep. 26, 2025

(51) Int. Cl. H04W 74/0816; H04W 74/04; H04W 76/12

(52) U.S. Cl. CPC H04W 74/0816; H04W 74/04; H04W 76/12

(57) ABSTRACT

The embodiments of the present disclosure relate to the technical field of mobile communications. Provided are a communication method, an electronic device, and a storage medium. The communication method is applied to an access point (AP) device, and the method comprises: determining a first radio frame, wherein the first radio frame comprises first identification information, and the first identification information identifies whether first restricted target wake time (R-TWT) scheduling is used for transmitting low-latency traffic data between tunneled direct link setup (TDLS) devices; and sending the first radio frame. The embodiments of the present disclosure provide a method for improving an R-TWT mechanism.

### CROSS-REFERENCE TO RELATED APPLICATION

The application is a U.S. National Stage of International Application No. PCT/CN2023/085192 filed on Mar. 30, 2023, the entire content of which is incorporated herein by reference.

### TECHNICAL FIELD

The embodiments of the present disclosure relate to the technical field of mobile communication, and in particular, to a communication method, an electronic device, and a storage medium.

### BACKGROUND

In the currently researched Wireless Fidelity (Wi-Fi) technology, the target wake time (TWT) mechanism has been proposed to support energy conservation operations for large-scale Internet of Things (IoT) devices. Meanwhile, the restricted-TWT (R-TWT) mechanism has been proposed to ensure the transmission of latency sensitive traffic.

### SUMMARY

Embodiments of the present disclosure provide a communication method, an electronic device, and a storage medium.

In one aspect, an embodiment of the present disclosure provides a communication method, applied to an access point (AP), and the method includes:
determining a first wireless frame; where the first wireless frame includes first identification information, and the first identification information identifies whether a first restricted target wake time (R-TWT) schedule is used for transmitting low-latency service data between tunneled direct link setup (TDLS) devices; and
sending the first wireless frame.

In another aspect, an embodiment of the present disclosure further provides a communication method, applied to a first TDLS device, and the method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

In another aspect, an embodiment of the present disclosure further provides a communication method, applied to a second TDLS device, and the method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

In another aspect, an embodiment of the present disclosure further provides an electronic device, where the electronic device is an access point (AP), and the electronic device includes:
a determining module, configured to determine a first wireless frame; where the first wireless frame includes first identification information, and the first identification information identifies whether a first restricted target wake time (R-TWT) schedule is used for transmitting low-latency service data between tunneled direct link setup (TDLS) devices; and
a sending module, configured to send the first wireless frame.

In another aspect, an embodiment of the present disclosure further provides an electronic device, where the electronic device is a first TDLS device, and the electronic device includes:
a first receiving module, configured to receive a first wireless frame; where the first wireless frame includes first identification information, and the first identification information identifies whether a first restricted target wake time (R-TWT) schedule is used for transmitting low-latency service data between tunneled direct link setup (TDLS) devices.

In another aspect, an embodiment of the present disclosure further provides an electronic device, where the electronic device is a second TDLS device, and the electronic device includes:
a second receiving module, configured to receive a first wireless frame; where the first wireless frame includes first identification information, and the first identification information identifies whether a first restricted target wake time (R-TWT) schedule is used for transmitting low-latency service data between tunneled direct link setup (TDLS) devices.

An embodiment of the present disclosure further provides an electronic device, including a memory, a processor, and a computer program stored in the memory and executable on the processor, where the processor, when executing the program, implements one or more methods described in the embodiments of the present disclosure.

An embodiment of the present disclosure further provides a computer-readable storage medium, on which a computer program is stored, where the computer program, when executed by a processor, implements one or more methods described in the embodiments of the present disclosure.

Additional aspects and advantages of the embodiments of the present disclosure will be partially provided in the description below, which will become apparent from the description below, or will be learned through the practice of the present disclosure.

### BRIEF DESCRIPTION OF THE DRAWINGS

In order to more clearly illustrate the technical solutions of the embodiments of the present disclosure, the accompanying drawings that are to be used in the description of the embodiments of the present disclosure are briefly introduced below. Obviously, the drawings in the following description are only some embodiments of the present disclosure, and those of ordinary skill in the art may obtain other drawings based on these drawings without paying creative effort.

FIG. 1 is a first flow chart of a communication method provided by an embodiment of the present disclosure;

FIG. 2 is a schematic diagram of a first example of an embodiment of the present disclosure;

FIG. 3 is a schematic diagram of a second example of an embodiment of the present disclosure;

FIG. 4 is a schematic diagram of a third example of an embodiment of the present disclosure;

FIG. 5 is a second flow chart of a communication method provided by an embodiment of the present disclosure;

FIG. 6 is a third flow chart of a communication method provided by an embodiment of the present disclosure;

FIG. 7 is a first schematic structural diagram of an electronic device provided by an embodiment of the present disclosure;

FIG. 8 is a second schematic structural diagram of an electronic device provided by an embodiment of the present disclosure;

FIG. 9 is a third schematic structural diagram of an electronic device provided by an embodiment of the present disclosure; and

FIG. 10 is a fourth schematic structural diagram of an electronic device provided by an embodiment of the present disclosure.

### DETAILED DESCRIPTION

Exemplary embodiments are described in detail herein, examples of which are represented in the accompanying drawings. When the following description relates to the drawings, the same numerals in different accompanying drawings represent the same or similar elements unless otherwise indicated. The implementations described in the following exemplary embodiments do not represent all implementations consistent with the embodiments of the present disclosure. To the contrary, they are merely examples of apparatuses and methods that are consistent with some aspects of the embodiments of the present disclosure.

Terms used in the embodiments of the present disclosure are used solely for the purpose of describing certain embodiments and are not intended to limit the embodiments of the present disclosure. The singular forms of “a/an”, “said” and “the” used in the embodiments of the present disclosure are also intended to include plural forms unless the context clearly indicates other meanings. It should also be understood that the term “and/or” used herein refers to and includes any or all possible combinations of one or more associated listed items. For example, A and/or B may represent: A exists alone, A and B exist at the same time, and B exists alone. The character “/” generally indicates that the objects associated before and after are in an “or” relationship. The term “plurality” refers to two or more. In view of this, the term “plurality” can also be understood as “at least two” in the embodiments of the present disclosure.

It should be understood that although the terms first, second, third, etc. may be used to describe various information in the embodiments of the present disclosure, and such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when . . . ” or “while . . . ” or “in response to determination”.

The technical solutions in the embodiments of the present disclosure are clearly and completely described below with reference to the accompanying drawings in the embodiments of the present disclosure. Obviously, the described embodiments are only a part of the embodiments of the present disclosure, and not all of them. Based on the embodiments in the present disclosure, all other embodiments obtained by those of ordinary skill in the art without making creative efforts shall fall within the protection scope of the present disclosure.

In order to further reduce the power consumption of Wi-Fi networks, there is a need to improve the R-TWT mechanism. The embodiments of the present disclosure provide a communication method, an electronic device, and a storage medium to further improve the R-TWT mechanism and reduce the power consumption of the Wi-Fi networks.

The method and the apparatus are based on the same application concept. Since the principles of the method and the apparatus for solving problems are similar, the implementations of the apparatus and the method may refer to each other, and the repeated parts will not be described again.

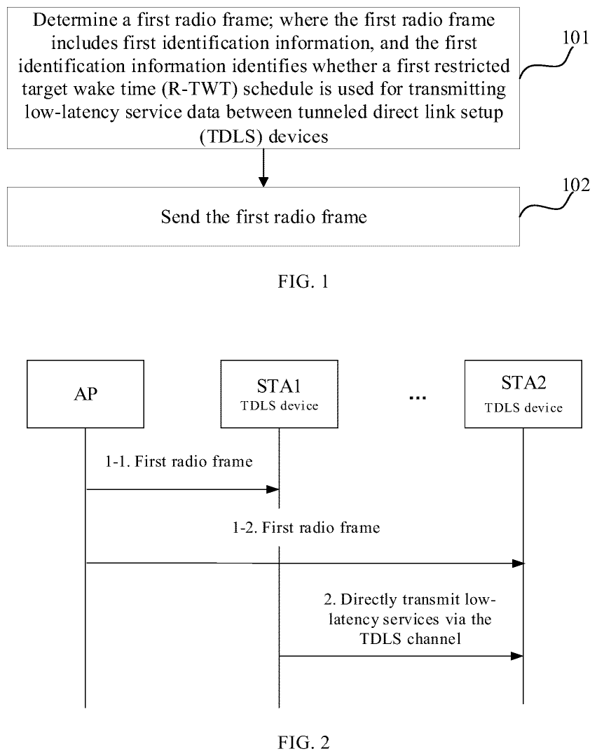

As shown in FIG. 1, an embodiment of the present disclosure provides a communication method. Optionally, the method may be applied to an access point (AP). Optionally, in the embodiments of the present disclosure, the AP, for example, a device with wireless-to-wired bridging functionality, is responsible for extending the services provided by the wired network to the wireless network; a station (STA), for example, an electronic device with wireless network access functionality, provides a frame delivery service to enable information transmission. Optionally, in embodiments of the present disclosure, the AP and the STA may be devices that support multiple links, for example, they may be referred to as an AP MLD and a non-AP MLD, respectively. An AP MLD may represent an access point that supports multiple links, while a non-AP MLD may represent a station that supports multiple links.

The method may include the following steps.

In step 101: a first wireless frame is determined; where the first wireless frame includes first identification information, and the first identification information identifies whether a first restricted target wake time (R-TWT) schedule is used for transmitting low-latency service data between tunneled direct link setup (TDLS) devices.

In step 102, the first wireless frame is sent.

TWT is a technology for energy conservation, which is designed to further reduce power consumption of Wi-Fi networks. Specifically, TWT enables an STA and an AP to negotiate a service period (SP) to determine the time and frequency of sleep and wake-up for STA. The STA keeps the active state and communicates during the service period, and thus can enter a sleep state outside of the service period, thereby achieving the goal of energy conservation. In addition, the TWT technology can also enable the AP to provide higher-quality services to multiple STAs, minimize competition or overlap, thereby reducing the power consumption of Wi-Fi networks while improving spectrum efficiency.

In low-latency transmission scenarios, the real-time data traffic of many applications has strict latency requirements. For example, the order of magnitude of average latency or maximum latency ranges from a few milliseconds to tens of milliseconds, and applications require real-time data traffic to have extremely low jitter and high reliability. To further ensure the communication of low-latency services, based on the TWT technology, the restricted-target wake time (R-TWT) mechanism is proposed. The R-TWT mechanism allows the AP to use enhanced media access protection mechanisms and resource reservation mechanisms to provide more predictable latency, so as to distinguish latency-sensitive traffic from other types of traffic, which enables the AP to reduce latency and/or jitter in worst-case, and provide services with higher reliability.

In the embodiments of the present disclosure, the scheduling device (such as an AP, or referred to as a scheduling AP) and the scheduled device (such as STA, or referred to as scheduled STA) of R-TWT may pre-establish an R-TWT schedule. AP broadcasts R-TWT schedules, and the STA negotiates with AP to become a member of a certain R-TWT schedule. During the service period (SP) of corresponding R-TWT, the AP and the STA only transmit the uplink and downlink low-latency services identified by the R-TWT schedule, while other communication services are suspended or delayed during this period. Specifically, R-TWT is used to serve low-latency services, such as services with an average latency of less than 10 milliseconds. Within the R-TWT SP, only services identified as low-latency services communicate, and other communication services are suspended or delayed during this period, thereby ensuring the transmission of low-latency services.

The AP determines a first wireless frame; where the first wireless frame includes first identification information, and the first identification information identifies whether the first R-TWT schedule is used for transmitting low-latency service data between TDLS devices. TDLS devices refer to, for example, two STAs. The TDLS technology enables two STAs in the same basic service set (BSS) to transmit data directly by bypassing the AP after establishing a TDLS Link, thereby being free from the constraints of the AP and using the fastest rate standard supported by the two STAs for performing direct transmission. Direct transmission may be carried out on the original channel or switched to a new extended channel. Therefore, it can avoid data transmission delays caused by network congestion, which is of great significance for the transmission of low-latency services. In the embodiments of the present disclosure, the AP uses the first identification information to identify whether the first R-TWT schedule is used for transmitting low-latency service data between TDLS devices. For R-TWT schedule applicable to TDLS devices, the TDLS devices can directly transmit low-latency services through the TDLS channel within the SP of the R-TWT schedule without the participation of the AP. This further improves the transmission efficiency of low-latency services and optimizes the R-TWT mechanism.

Optionally, in the embodiments of the present disclosure, the first wireless frame includes a beacon frame or a probe response frame.

As a first example, reference is made to FIG. 2, which illustrates a specific application scenario in the embodiments of the present disclosure. As shown in FIG. 2, the AP performs step 1 (including sub-steps 1-1, 1-2, . . . , 1-n; these sub-steps may be executed simultaneously or sequentially), sending a first wireless frame that carries first identification information. The first identification information is used to indicate whether the first R-TWT schedule is used for transmitting low-latency service data between TDLS devices. STA1 and STA2 establish a TDLS link. When it is determined that the first R-TWT schedule is applicable to TDLS devices based on the first identification information, STA1 and STA2 directly transmit low-latency services through the TDLS channel within the SP of the R-TWT schedule.

In addition, according to actual needs, the step 1 (including sub-steps 1-1, 1-2, . . . , 1-n, these sub-steps may be performed simultaneously or sequentially) performed by the AP may also be carried after the STA1 and STA2 establish a TDLS link, where a first wireless frame that carries first identification information is sent in step 1, and the first identification information is used to indicate whether the first R-TWT schedule is used for transmitting low-latency service data between TDLS devices. The specific operation method for this scenario is the same as the method used when sending the corresponding first wireless frame before the TDLS link is established.

An embodiment of the present disclosure provides a communication method, which is applied to an access point (AP). The method includes:
determining a first wireless frame; where the first wireless frame include first identification information, and the first identification information identifies whether a first R-TWT schedule is used for transmitting low-latency service data between TDLS devices; and
sending the first wireless frame.

The first wireless frame includes a TWT element.

The TWT element includes a Broadcast TWT parameter set field.

The first identification information is carried in a broadcast TWT information (Broadcast TWT Info) subfield of the Broadcast TWT parameter set field.

The AP carries the first identification information in the Broadcast TWT Info subfield, which is used to indicate whether the R-TWT schedule can be used to negotiate R-TWT SP between TDLS devices for low-latency service transmission.

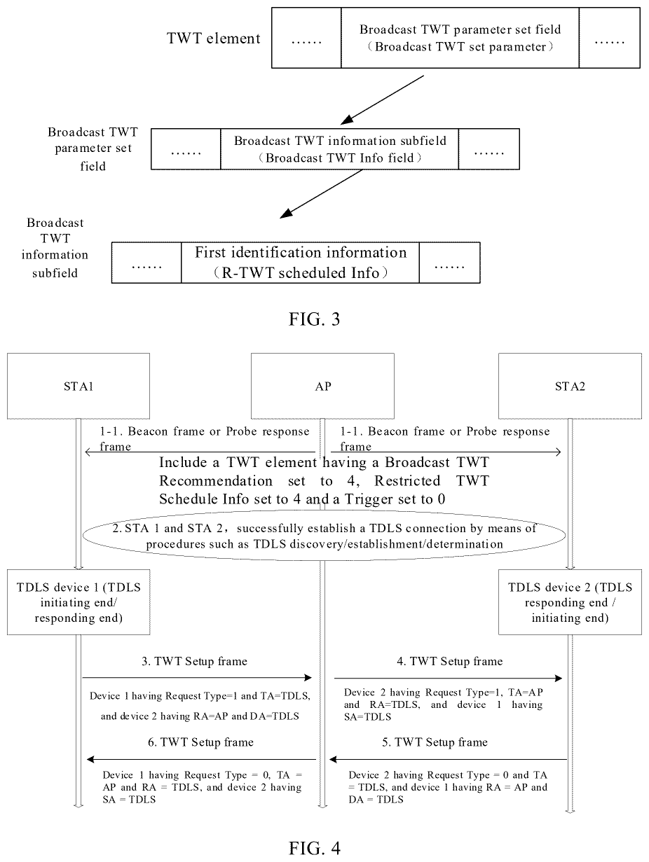

As a second example, as shown in FIG. 3, the TWT element includes a broadcast TWT parameter set field, the broadcast TWT parameter set field includes the broadcast TWT information subfield, and the first identification information is carried in the broadcast TWT information subfield. FIG. 3 takes the example where first identification information is the R-TWT Schedule Info identification bit. The TWT element may contain one or more broadcast TWT parameter sets.

An embodiment of the present disclosure provides a communication method, which is applied to an access point (AP). The method includes:
determining a first wireless frame; where the first wireless frame include first identification information, and the first identification information identifies whether a first R-TWT schedule is used for transmitting low-latency service data between TDLS devices; and
sending the first wireless frame.

The first wireless frame includes a TWT element; the TWT element includes a broadcast TWT parameter set field; the first identification information is carried in the broadcast TWT information (Broadcast TWT Info) subfield of the broadcast TWT parameter set field.

The broadcast TWT parameter set field further includes a broadcast TWT recommendation (Broadcast TWT Recommendation) subfield.

The broadcast TWT recommendation subfield is set to a first parameter value, for example, the first parameter value is set to 4, which indicates that a type of the broadcast TWT parameter set field is an R-TWT parameter set.

An embodiment of the present disclosure provides a communication method, which is applied to an access point (AP). The method includes:
determining a first wireless frame; where the first wireless frame include first identification information, and the first identification information identifies whether a first R-TWT schedule is used for transmitting low-latency service data between TDLS devices; and
sending the first wireless frame.

The first wireless frame includes a TWT element.

The TWT element includes a broadcast TWT parameter set field; the first identification information is carried in the broadcast TWT information (Broadcast TWT Info) subfield of the broadcast TWT parameter set field.

The broadcast TWT parameter set field includes a trigger identification bit, and the trigger identification bit is set to a second parameter value, for example, the second parameter value is set to 0, which indicates that a service period of the first R-TWT schedule does not include a trigger frame.

An embodiment of the present disclosure provides a communication method, which is applied to an access point (AP). The method includes:
determining a first wireless frame; where the first wireless frame include first identification information, and the first identification information identifies whether a first R-TWT schedule is used for transmitting low-latency service data between TDLS devices; and
sending the first wireless frame.

The first wireless frame includes a TWT element.

The TWT element includes a broadcast TWT parameter set field; the first identification information is carried in the broadcast TWT information (Broadcast TWT Info) subfield of the broadcast TWT parameter set field.

The broadcast TWT parameter set field includes a restricted TWT traffic information (Restricted TWT Traffic Info) subfield; the restricted TWT traffic information subfield includes a TDLS traffic identifier bitmap valid (TDLS TID Bitmap Valid) identification bit. The TDLS traffic identifier bitmap valid identification bit is set to a third parameter value, for example, the fourth parameter value is 1, which indicates that the restricted TWT traffic information subfield includes a TWT TDLS traffic identifier bitmap (TWT TDLS TID Bitmap). TID is a traffic identifier.

As an example, the format of the restricted TWT traffic information subfield is as shown in Table 1 below.

TABLE 1

| | | | |
|---|---|---|---|
| Traffic Info | Restricted TWT DL | Restricted TWT | Restricted TWT |
| Control | TID Bitmap | UL TID Bitmap | TDLS TID |
| | | | Bitmap |

As an example, the TWT TDLS TID Bitmap Valid identification bit included in the restricted TWT traffic information subfield is 1, which indicates that the restricted TWT traffic information subfield includes the TWT TDLS traffic identifier bitmap (TWT TDLS TID Bitmap). Taking the example where the TWT TDLS TID Bitmap Valid identification exists in the traffic Info Control field, the format of the Traffic Info Control field is shown in Table 2 below.

TABLE 2

| | | | |
|---|---|---|---|
| DL TID | UL TID Bitmap | Restricted TWT | Reserved |
| Bitmap Valid | Valid | TDLS TID Bitmap | |
| | | Valid | |

An embodiment of the present disclosure provides a communication method, which is applied to an access point (AP). The method includes:
determining a first wireless frame; where the first wireless frame includes first identification information, and the first identification information identifies whether a first R-TWT schedule is used for transmitting low-latency service data between TDLS devices; and
sending the first wireless frame.

The first wireless frame includes a TWT element.

The TWT element includes a broadcast TWT parameter set field; the first identification information is carried in the broadcast TWT information (Broadcast TWT Info) subfield of the broadcast TWT parameter set field, and the first identification information includes a restricted TWT schedule information (Restricted TWT Schedule Info) identification bit.

As an example, when the first identification information includes the Restricted TWT Schedule Info identification bit, the format of the Broadcast TWT Info subfield is as shown in Table 3 below.

TABLE 3

| | Restricted | | | | |
|---|---|---|---|---|---|
| | TWT | Restricted | | | |
| | Traffic | TWT | | Broadcast | |
| Information | Info | Schedule | Broadcast | TWT | |
| content | Present | Info | TWT ID | Persistence | Reserved |
| Octets | 1 | 3 | 5 | 8 | 7 |

The restricted TWT schedule information subfield is set to a fourth parameter value, for example, the third parameter value is 4, which indicates that the first R-TWT schedule is used for transmitting low-latency service data between TDLS devices. As an example, it is shown in the following Table 4.

TABLE 4

| Restricted TWT | |
|---|---|
| Schedule Info | |
| value | Description |
| . . . | . . . |
| 4 | Corresponding R-TWT SP may be |
| | used for transmitting low-latency |
| | services between TDLS devices |
| . . . | Reserved |

An embodiment of the present disclosure provides a communication method, which is applied to an access point (AP). The method includes:
determining a first wireless frame; where the first wireless frame include first identification information, and the first identification information identifies whether a first R-TWT schedule is used for transmitting low-latency service data between TDLS devices;
sending the first wireless frame;
receiving a first TWT setup request frame sent by a first TDLS device; and
in response to the first TWT setup request frame, sending a second TWT setup request frame to a second TDLS device;
where the first TWT setup request frame and the second TWT setup request frame request: setting up the first R-TWT schedule on a TDLS channel between the first TDLS device and the second TDLS device.

After the TDLS initiator (one of the first TDLS device and the second TDLS device) and the TDLS responder (the other of the first TDLS device and the second TDLS device) receive the first wireless frame and successfully establish a TDLS link, either the TDLS initiator or the TDLS responder may send a first TWT setup request frame to the other party via the AP. The first TWT setup request frame is used to request to establish a first R-TWT schedule on the TDLS channel between the first TDLS device and the second TDLS device, that is, to apply the first R-TWT schedule to the already established TDLS link between the two devices.

Furthermore, in the first TWT setup request frame, the key parameters are as follows:
(1) The Request Type subfield is set to 1 to identify that the TWT setup frame is a TWT setup request;
(2) The Transmission Address (TA) is set to the Media Access Control (MAC) address of the first TDLS device;
(3) The Receiver Address (RA) is set to the MAC address of AP; and
(4) The Destination Address (DA) is set to the MAC address of the second TDLS device.

The AP receives the first TWT setup request frame and sends a second TWT setup request frame to the second TDLS device. The key parameters in the second TWT setup request frame are as follows:
(1) The Request Type subfield is set to 1 to identify that the TWT setup frame is a TWT setup request;
(2) TA is set to the MAC address of AP;
(3) RA is set to the MAC address of the second TDLS device; and
(4) The source address (SA) is set to the MAC address of the first TDLS device.

As a third example, reference is made to FIG. 4, which shows a specific application scenario in the embodiments of the present disclosure.

As shown in FIG. 4, the AP performs Step 1 (1-1, 1-2, . . . , 1-n; each sub-step may be performed simultaneously or sequentially), sending a first wireless frame (Beacon frame or Probe response frame) that carries a TWT element.

In the TWT element:

Broadcast TWT Recommendation subfield is set to 4, the Restricted TWT Schedule Info identification bit is set to 4, and the Trigger field is set to 0.

STA1 (the first TDLS device) and STA2 (the second TDLS device) perform Step 2, and successfully establish a TDLS link through processes such as TDLS discovery, TDLS establishment, and TDLS confirmation, etc.

STA1 performs Step 3, sending a TWT Setup frame (the first TWT setup request frame) to the AP. In the TWT Setup frame, Request Type=1, TA=the MAC address of TDLS device 1, RA=the MAC address of the AP, and DA=the MAC address of TDLS device 2.

The AP executes Step 4, forwarding a TWT Setup frame (the second TWT setup request frame) to STA2. In the TWT Setup frame, Request Type=1, TA=the MAC address of the AP, RA=the MAC address of TDLS device 2, and Source Address (SA)=the MAC address of TDLS device 1.

An embodiment of the present disclosure provides a communication method, which is applied to an access point (AP). The method includes:
determining a first wireless frame; where the first wireless frame include first identification information, and the first identification information identifies whether a first R-TWT schedule is used for transmitting low-latency service data between TDLS devices;
sending the first wireless frame;
receiving a first TWT setup request frame sent by a first TDLS device; and
in response to the first TWT setup request frame, sending a second TWT setup request frame to a second TDLS device;
where the first TWT setup request frame and the second TWT setup request frame request: setting up the first R-TWT schedule on a TDLS channel between the first TDLS device and the second TDLS device;
receiving a second TWT setup response frame sent by the second TDLS device; and
in response to the second TWT setup response frame, sending a first TWT setup response frame to the first TDLS device.

After the AP sends the second TWT setup request frame to the second TDLS device, it receives the second TWT setup response frame sent by the second TDLS device, and then sends the first TWT setup response frame to the first TDLS device based on the second TWT setup response frame. Specifically, the key parameters in the second TWT setup response frame are as follows.
(1) The Request Type subfield is set to 0 to identify that the TWT setup frame is a TWT setup response;
(2) TA is set to the MAC address of the second TDLS device;
(3) RA is set to the MAC address of the AP;
(4) DA is set to the MAC address of the first TDLS device.

In the first TWT setup response frame, the key parameters are as follows.
(1) The request type subfield is set to 0 to identify that the TWT setup frame is a TWT setup response;
(2) TA is set to the MAC address of the AP;
(3) RA is set to the MAC address of the first TDLS device;
(4) SA is set to the MAC address of the second TDLS device.

Continuing to refer to the third example and FIG. 4, after AP executes step 4, STA2 executes Step 5, sending a TWT Setup frame (second TWT setup response frame) to the AP. In the TWT Setup frame, Request Type=0, TA is set to the MAC address of TDLS device 2, RA is set to the MAC address of the AP, and DA is set to the MAC address of TDLS device 1.

AP executes Step 6, forwarding TWT Setup frame (first TWT setup response frame) to STA1. In the TWT Setup frame, Request Type=0, TA is set to the MAC address of the AP, RA is set to the MAC address of TDLS device 1, and SA is set to the MAC address of TDLS device 2.

In the embodiments of the present disclosure, the AP determines a first wireless frame, and in the first wireless frame, uses first identification information to identify whether the first R-TWT schedule is used for transmitting low-latency service data between TDLS devices. For an R-TWT schedule that can be applied between TDLS devices, the TDLS devices can transmit low-latency services directly through the TDLS channel within the SP of the R-TWT schedule without the participation of the AP, thereby further improving the transmission efficiency of low-latency traffic and optimizing the R-TWT mechanism.

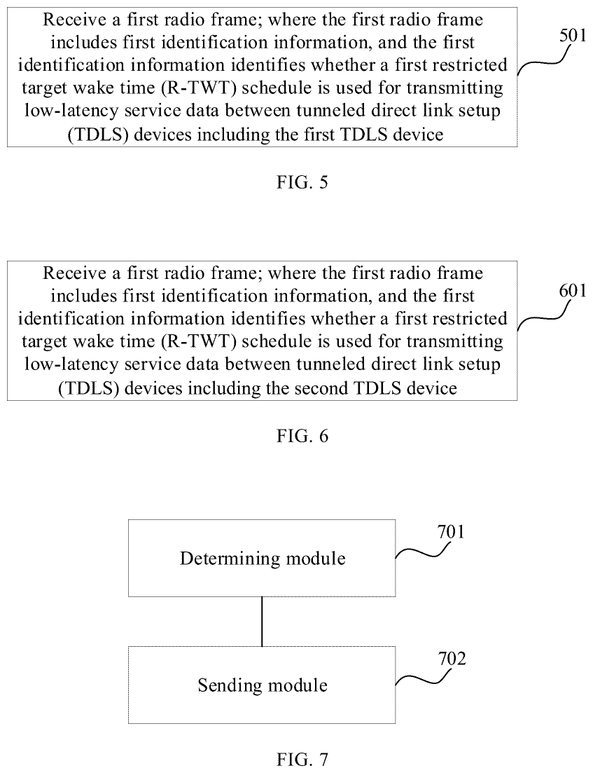

Referring to FIG. 5, an embodiment of the present disclosure provides a communication method. Optionally, the method may be applied to a first TDLS device, which may be an STA. The method may include the following steps.

In step 501, a first wireless frame is received; where the first wireless frame includes first identification information, and the first identification information identifies whether a first restricted target wake time (R-TWT) schedule is used for transmitting low-latency service data between tunneled direct link setup (TDLS) devices including the first TDLS device.

The application scenario of the communication method provided in the embodiment of the present disclosure refers to the aforementioned first example, which will not be repeated here.

In the embodiments of the present disclosure, the scheduling device (such as an AP, or referred to as a scheduling AP) and the scheduled device (such as STA, or referred to as scheduled STA) of R-TWT may pre-establish an R-TWT schedule. AP broadcasts R-TWT schedules, and the STA negotiates with AP to become a member of a certain R-TWT schedule. During the service period (SP) of corresponding R-TWT, the AP and the STA only transmit the uplink and downlink low-latency services identified by the R-TWT schedule, while other communication services are suspended or delayed during this period. Specifically, R-TWT is used to serve low-latency services, such as services with an average latency of less than 10 milliseconds. Within the R-TWT SP, only services identified as low-latency services communicate, and other communication services are suspended or delayed during this period, thereby ensuring the transmission of low-latency services.

The first TDLS device receives a first wireless frame; where the first wireless frame includes first identification information, and the first identification information identifies whether the first R-TWT scheduling is used for transmitting low-latency service data between TDLS devices. TDLS devices refer to, for example, two STAs. The TDLS technology enables two STAs in the same basic service set (BSS) to transmit data directly by bypassing the AP after establishing a TDLS Link, thereby being free from the constraints of the AP and using the fastest rate standard supported by the two STAs for performing direct transmission. Direct transmission may be carried out on the original channel or switched to a new extended channel. Therefore, it can avoid data transmission delays caused by network congestion, which is of great significance for the transmission of low-latency services. In the embodiments of the present disclosure, the first identification information is used to identify whether the first R-TWT schedule is used for transmitting low-latency service data between TDLS devices. For R-TWT schedule applicable to TDLS devices, the TDLS devices can directly transmit low-latency services through the TDLS channel within the SP of the R-TWT schedule without the participation of the AP. This further improves the transmission efficiency of low-latency services and optimizes the R-TWT mechanism.

Optionally, in the embodiments of the present disclosure, the first wireless frame includes a beacon frame or a probe response frame.

An embodiment of the present disclosure provides a communication method. Optionally, the method may be applied to a first TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a Broadcast TWT parameter set field. The first identification information is carried in a broadcast TWT information (Broadcast TWT Info) subfield of the Broadcast TWT parameter set field. The AP carries the first identification information in the Broadcast TWT Info subfield, which is used to indicate whether the R-TWT schedule can be used to negotiate R-TWT SP between TDLS devices for low-latency service transmission.

As a second example, as shown in FIG. 3, the TWT element includes a broadcast TWT parameter set field, the broadcast TWT parameter set field includes the broadcast TWT information subfield, and the first identification information is carried in the broadcast TWT information subfield. FIG. 3 takes the example where first identification information is the R-TWT Schedule Info identification bit.

An embodiment of the present disclosure provides a communication method. Optionally, the method may be applied to a first TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field. The broadcast TWT parameter set field further includes a broadcast TWT recommendation (Broadcast TWT Recommendation) subfield.

The broadcast TWT recommendation subfield is set to a first parameter value, for example, the first parameter value is set to 4, which indicates that a type of the broadcast TWT parameter set field is an R-TWT parameter set.

An embodiment of the present disclosure provides a communication method. Optionally, the method may be applied to a first TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field. The broadcast TWT parameter set field includes a trigger identification bit, and the trigger identification bit is set to a second parameter value, for example, the second parameter value is set to 0, which indicates that a service period of the first R-TWT schedule does not include a trigger frame.

An embodiment of the present disclosure provides a communication method. Optionally, the method may be applied to a first TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field. The broadcast TWT parameter set field includes a restricted TWT traffic information (Restricted TWT Traffic Info) subfield.

The restricted TWT traffic information subfield includes a TDLS traffic identifier bitmap valid (TDLS TID Bitmap Valid) identification bit. The TDLS traffic identifier bitmap valid identification bit is set to a third parameter value, for example, the fourth parameter value is 1, which indicates that the restricted TWT traffic information subfield includes a TWT TDLS traffic identifier bitmap (TWT TDLS TID Bitmap). TID is a traffic identifier.

As an example, the format of the restricted TWT traffic information subfield is as shown in the above Table 1, which will not be repeated here. The TWT TDLS TID Bitmap Valid identification bit included in the restricted TWT traffic information subfield is 1, which indicates that the restricted TWT traffic information subfield includes the TWT TDLS traffic identifier bitmap (TWT TDLS TID Bitmap). Taking the example where the TWT TDLS TID Bitmap Valid identification exists in the traffic Info Control field, the format of the Traffic Info Control field is shown in the above Table 2, which will not be repeated here.

An embodiment of the present disclosure provides a communication method. Optionally, the method may be applied to a first TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field, and the first identification information includes a restricted TWT schedule information (Restricted TWT Schedule Info) identification bit.

As an example, when the first identification information includes the Restricted TWT Schedule Info identification bit, the format of the Broadcast TWT Info subfield is as shown in the above Table 3, which will not be repeated here. The restricted TWT schedule information subfield is set to a fourth parameter value, for example, the third parameter value is 4, which indicates that the first R-TWT schedule is used for transmitting low-latency service data between TDLS devices. As an example, it is shown in the above Table 4, which will not be repeated here.

An embodiment of the present disclosure provides a communication method. Optionally, the method may be applied to a first TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field.

A first TWT setup request frame is sent to an access point (AP), and the first TWT setup request frame instructs the AP to send a second TWT setup request frame to a second TDLS device in response to the first TWT setup request frame.

The first TWT setup request frame and the second TWT setup request frame request: setting up the first R-TWT schedule on a TDLS channel between the first TDLS device and the second TDLS device.

After the TDLS initiator (one of the first TDLS device and the second TDLS device) and the TDLS responder (the other of the first TDLS device and the second TDLS device) receive the first wireless frame and successfully establish a TDLS link, either the TDLS initiator or the TDLS responder may send a first TWT setup request frame to the other party via the AP. The first TWT setup request frame is used to request to establish a first R-TWT schedule on the TDLS channel between the first TDLS device and the second TDLS device, that is, to apply the first R-TWT schedule to the already established TDLS link between the two devices.

Furthermore, in the first TWT setup request frame, the key parameters are as follows:
(1) The Request Type subfield is set to 1 to identify that the TWT setup frame is a TWT setup request;
(2) The Transmission Address (TA) is set to the Media Access Control (MAC) address of the first TDLS device;
(3) The Receiver Address (RA) is set to the MAC address of AP; and
(4) The Destination Address (DA) is set to the MAC address of the second TDLS device.

The AP receives the first TWT setup request frame and sends a second TWT setup request frame to the second TDLS device. The key parameters in the second TWT setup request frame are as follows:
(1) The Request Type subfield is set to 1 to identify that the TWT setup frame is a TWT setup request;
(2) TA is set to the MAC address of AP;
(3) RA is set to the MAC address of the second TDLS device; and
(4) The source address (SA) is set to the MAC address of the first TDLS device.

As a third example, reference is made to FIG. 4, which shows a specific application scenario in the embodiments of the present disclosure.

As shown in FIG. 4, the AP performs Step 1 (1-1, 1-2, . . . , 1-n; each sub-step may be performed simultaneously or sequentially), sending a first wireless frame (Beacon frame or Probe response frame) that carries a TWT element.

In the TWT element:

Broadcast TWT Recommendation subfield is set to 4, the Restricted TWT Schedule Info identification bit is set to 4, and the Trigger field is set to 0.

STA1 (the first TDLS device) and STA2 (the second TDLS device) perform Step 2, and successfully establish a TDLS link through processes such as TDLS discovery, TDLS establishment, and TDLS confirmation, etc.

STA1 performs Step 3, sending a TWT Setup frame (the first TWT setup request frame) to the AP. In the TWT Setup frame, Request Type=1, TA=the MAC address of TDLS device 1, RA=the MAC address of the AP, and DA=the MAC address of TDLS device 2.

The AP executes Step 4, forwarding a TWT Setup frame (the second TWT setup request frame) to STA2. In the TWT Setup frame, Request Type=1, TA=the MAC address of the AP, RA=the MAC address of TDLS device 2, and Source Address (SA)=the MAC address of TDLS device 1.

An embodiment of the present disclosure provides a communication method. Optionally, the method may be applied to a first TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field.

A first TWT setup request frame is sent to an access point (AP), and the first TWT setup request frame instructs the AP to send a second TWT setup request frame to a second TDLS device in response to the first TWT setup request frame.

The first TWT setup request frame and the second TWT setup request frame request: setting up the first R-TWT schedule on a TDLS channel between the first TDLS device and the second TDLS device. A first TWT setup response frame sent by the AP is received, where the first TWT setup response frame is sent by the AP in response to the second TWT setup response frame sent by the second TDLS device.

After the AP sends the second TWT setup request frame to the second TDLS device, it receives the second TWT setup response frame sent by the second TDLS device, and then sends the first TWT setup response frame to the first TDLS device based on the second TWT setup response frame. Specifically, the key parameters in the second TWT setup response frame are as follows.
(1) The Request Type subfield is set to 0 to identify that the TWT setup frame is a TWT setup response;
(2) TA is set to the MAC address of the second TDLS device;
(3) RA is set to the MAC address of the AP;
(4) DA is set to the MAC address of the first TDLS device.

In the first TWT setup response frame, the key parameters are as follows.
(1) The request type subfield is set to 0 to identify that the TWT setup frame is a TWT setup response;
(2) TA is set to the MAC address of the AP;
(3) RA is set to the MAC address of the first TDLS device;
(4) SA is set to the MAC address of the second TDLS device.

Continuing to refer to the third example and FIG. 4, after AP executes step 4, STA2 executes Step 5, sending a TWT Setup frame (second TWT setup response frame) to the AP. In the TWT Setup frame, Request Type=0, TA is set to the MAC address of TDLS device 2, RA is set to the MAC address of the AP, and DA is set to the MAC address of TDLS device 1.

AP executes Step 6, forwarding TWT Setup frame (first TWT setup response frame) to STA1. In the TWT Setup frame, Request Type=0, TA is set to the MAC address of the AP, RA is set to the MAC address of TDLS device 1, and SA is set to the MAC address of TDLS device 2.

In the embodiments of the present disclosure, the first TDLS device receives a first wireless frame, obtains first identification information of the first wireless frame, and determines whether a first R-TWT schedule is used for transmitting low-latency service data between TDLS devices based on the first identification information. For an R-TWT schedule that can be applied between TDLS devices, the TDLS devices can transmit low-latency services directly through the TDLS channel within the SP of the R-TWT schedule without the participation of the AP, thereby further improving the transmission efficiency of low-latency traffic and optimizing the R-TWT mechanism.

Referring to FIG. 6, an embodiment of the present disclosure provides a communication method. Optionally, the method may be applied to a second TDLS device, which may be an STA. The method may include the following steps.

In step 601, a first wireless frame is received; where the first wireless frame includes first identification information, and the first identification information identifies whether a first restricted target wake time (R-TWT) schedule is used for transmitting low-latency service data between tunneled direct link setup (TDLS) devices including the second TDLS device.

The application scenario of the communication method provided in the embodiment of the present disclosure refers to the aforementioned first example, which will not be repeated here.

In the embodiments of the present disclosure, the scheduling device (such as an AP, or referred to as a scheduling AP) and the scheduled device (such as STA, or referred to as scheduled STA) of R-TWT may pre-establish an R-TWT schedule. AP broadcasts R-TWT schedules, and the STA negotiates with AP to become a member of a certain R-TWT schedule. During the service period (SP) of corresponding R-TWT, the AP and the STA only transmit the uplink and downlink low-latency services identified by the R-TWT schedule, while other communication services are suspended or delayed during this period. Specifically, R-TWT is used to serve low-latency services, such as services with an average latency of less than 10 milliseconds. Within the R-TWT SP, only services identified as low-latency services communicate, and other communication services are suspended or delayed during this period, thereby ensuring the transmission of low-latency services.

The second TDLS device receives a first wireless frame; where the first wireless frame includes first identification information, and the first identification information identifies whether the first R-TWT scheduling is used for transmitting low-latency service data between TDLS devices. TDLS devices refer to, for example, two STAs. The TDLS technology enables two STAs in the same basic service set (BSS) to transmit data directly by bypassing the AP after establishing a TDLS Link, thereby being free from the constraints of the AP and using the fastest rate standard supported by the two STAs for performing direct transmission. Direct transmission may be carried out on the original channel or switched to a new extended channel. Therefore, it can avoid data transmission delays caused by network congestion, which is of great significance for the transmission of low-latency services. In the embodiments of the present disclosure, the AP uses the first identification information to identify whether the first R-TWT schedule is used for transmitting low-latency service data between TDLS devices. For R-TWT schedule applicable to TDLS devices, the TDLS devices can directly transmit low-latency services through the TDLS channel within the SP of the R-TWT schedule without the participation of the AP. This further improves the transmission efficiency of low-latency services and optimizes the R-TWT mechanism.

Optionally, in the embodiments of the present disclosure, the first wireless frame includes a beacon frame or a probe response frame.

An embodiment of the present disclosure provides a communication method. Optionally, the method may be applied to a second TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a Broadcast TWT parameter set field. The first identification information is carried in a broadcast TWT information (Broadcast TWT Info) subfield of the Broadcast TWT parameter set field. The AP carries the first identification information in the Broadcast TWT Info subfield, which is used to indicate whether the R-TWT schedule can be used to negotiate R-TWT SP between TDLS devices for low-latency service transmission.

As a second example, as shown in FIG. 3, the TWT element includes a broadcast TWT parameter set field, the broadcast TWT parameter set field includes the broadcast TWT information subfield, and the first identification information is carried in the broadcast TWT information subfield. FIG. 3 takes the example where first identification information is the R-TWT Schedule Info identification bit.

An embodiment of the present disclosure provides a communication method. Optionally, the method may be applied to a second TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field. The broadcast TWT parameter set field further includes a broadcast TWT recommendation (Broadcast TWT Recommendation) subfield.

The broadcast TWT recommendation subfield is set to a first parameter value, for example, the first parameter value is set to 4, which indicates that a type of the broadcast TWT parameter set field is an R-TWT parameter set.

An embodiment of the present disclosure provides a communication method. Optionally, the method may be applied to a second TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field. The broadcast TWT parameter set field includes a trigger identification bit, and the trigger identification bit is set to a second parameter value, for example, the second parameter value is set to 0, which indicates that a service period of the first R-TWT schedule does not include a trigger frame.

An embodiment of the present disclosure provides a communication method. Optionally, the method may be applied to a second TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field. The broadcast TWT parameter set field includes a restricted TWT traffic information (Restricted TWT Traffic Info) subfield.

The restricted TWT traffic information subfield includes a TDLS traffic identifier bitmap valid (TDLS TID Bitmap Valid) identification bit. The TDLS traffic identifier bitmap valid identification bit is set to a third parameter value, for example, the fourth parameter value is 1, which indicates that the restricted TWT traffic information subfield includes a TWT TDLS traffic identifier bitmap (TWT TDLS TID Bitmap). TID is a traffic identifier.

As an example, the format of the restricted TWT traffic information subfield is as shown in the above Table 1, which will not be repeated here. The TWT TDLS TID Bitmap Valid identification bit included in the restricted TWT traffic information subfield is 1, which indicates that the restricted TWT traffic information subfield includes the TWT TDLS traffic identifier bitmap (TWT TDLS TID Bitmap). Taking the example where the TWT TDLS TID Bitmap Valid identification exists in the traffic Info Control field, the format of the Traffic Info Control field is shown in the above Table 2, which will not be repeated here.

An embodiment of the present disclosure provides a communication method. Optionally, the method may be applied to a second TDLS device. The method includes:

receiving a first wireless frame; where the first wireless frame includes first identification information, and the first identification information identifies whether a first restricted target wake time (R-TWT) schedule is used for transmitting low-latency service data between tunneled direct link setup (TDLS) devices.

The first wireless frame includes a TWT element.

The TWT element includes a broadcast TWT parameter set field; the first identification information is carried in the broadcast TWT information (Broadcast TWT Info) subfield of the broadcast TWT parameter set field, and the first identification information includes a restricted TWT schedule information (Restricted TWT Schedule Info) identification bit.

As an example, when the first identification information includes the Restricted TWT Schedule Info identification bit, the format of the Broadcast TWT Info subfield is as shown in the above Table 3, which will not be repeated here. The restricted TWT schedule information subfield is set to a fourth parameter value, for example, the third parameter value is 4, which indicates that the first R-TWT schedule is used for transmitting low-latency service data between TDLS devices. As an example, it is shown in the above Table 4, which will not be repeated here.

An embodiment of the present disclosure provides a communication method.

Optionally, the method may be applied to a second TDLS device. The method includes:
receiving a first wireless frame; where the first wireless frame includes first identification information, and the first identification information identifies whether a first restricted target wake time (R-TWT) schedule is used for transmitting low-latency service data between tunneled direct link setup (TDLS) devices; and
receiving a second TWT setup request frame sent by an access point (AP); where the second TWT setup request frame is sent by the AP in response to the first TWT setup request frame sent by the first TDLS device;
where the first TWT setup request frame and the second TWT setup request frame request: setting up the first R-TWT schedule on a TDLS channel between the first TDLS device and the second TDLS device.

After the TDLS initiator (one of the first TDLS device and the second TDLS device) and the TDLS responder (the other of the first TDLS device and the second TDLS device) receive the first wireless frame and successfully establish a TDLS link, either the TDLS initiator or the TDLS responder may send a first TWT setup request frame to the other party via the AP. The first TWT setup request frame is used to request to establish a first R-TWT schedule on the TDLS channel between the first TDLS device and the second TDLS device, that is, to apply the first R-TWT schedule to the already established TDLS link between the two devices.

Furthermore, in the first TWT setup request frame, the key parameters are as follows:
(1) The Request Type subfield is set to 1 to identify that the TWT setup frame is a TWT setup request;
(2) The Transmission Address (TA) is set to the Media Access Control (MAC) address of the first TDLS device;
(3) The Receiver Address (RA) is set to the MAC address of AP; and
(4) The Destination Address (DA) is set to the MAC address of the second TDLS device.

The AP receives the first TWT setup request frame and sends a second TWT setup request frame to the second TDLS device. The key parameters in the second TWT setup request frame are as follows:
(1) The Request Type subfield is set to 1 to identify that the TWT setup frame is a TWT setup request;
(2) TA is set to the MAC address of AP;
(3) RA is set to the MAC address of the second TDLS device; and
(4) The source address (SA) is set to the MAC address of the first TDLS device.

As a third example, reference is made to FIG. 4, which shows a specific application scenario in the embodiments of the present disclosure.

As shown in FIG. 4, the AP performs Step 1 (1-1, 1-2, . . . , 1-n; each sub-step may be performed simultaneously or sequentially), sending a first wireless frame (Beacon frame or Probe response frame) that carries a TWT element.

In the TWT element:

Broadcast TWT Recommendation subfield is set to 4, the Restricted TWT Schedule Info identification bit is set to 4, and the Trigger field is set to 0.

STA1 (the first TDLS device) and STA2 (the second TDLS device) perform Step 2, and successfully establish a TDLS link through processes such as TDLS discovery, TDLS establishment, and TDLS confirmation, etc.

STA1 performs Step 3, sending a TWT Setup frame (the first TWT setup request frame) to the AP. In the TWT Setup frame, Request Type=1, TA=the MAC address of TDLS device 1, RA=the MAC address of the AP, and DA=the MAC address of TDLS device 2.

The AP executes Step 4, forwarding a TWT Setup frame (the second TWT setup request frame) to STA2. In the TWT Setup frame, Request Type=1, TA=the MAC address of the AP, RA=the MAC address of TDLS device 2, and Source Address (SA)=the MAC address of TDLS device 1.

An embodiment of the present disclosure provides a communication method.

Optionally, the method may be applied to a second TDLS device. The method includes:
receiving a first wireless frame; where the first wireless frame includes first identification information, and the first identification information identifies whether a first restricted target wake time (R-TWT) schedule is used for transmitting low-latency service data between tunneled direct link setup (TDLS) devices; and receiving a second TWT setup request frame sent by an access point (AP); where the second TWT setup request frame is sent by the AP in response to the first TWT setup request frame sent by the first TDLS device;
where the first TWT setup request frame and the second TWT setup request frame request: setting up the first R-TWT schedule on a TDLS channel between the first TDLS device and the second TDLS device; and
sending a second TWT setup response frame to the AP, which instructs the AP to send a first TWT setup response frame to the first TDLS device in response to the second TWT setup response frame.

After receiving the second TWT setup request frame sent by the AP, the second TDLS device sends a second TWT setup response frame to the AP, which instructs the AP to send the first TWT setup response frame to the first TDLS device based on the second TWT setup response frame. Specifically, the key parameters in the second TWT setup response frame are as follows.
(1) The Request Type subfield is set to 0 to identify that the TWT setup frame is a TWT setup response;
(2) TA is set to the MAC address of the second TDLS device;
(3) RA is set to the MAC address of the AP;
(4) DA is set to the MAC address of the first TDLS device.

In the first TWT setup response frame, the key parameters are as follows.
(1) The request type subfield is set to 0 to identify that the TWT setup frame is a TWT setup response;
(2) TA is set to the MAC address of the AP;
(3) RA is set to the MAC address of the first TDLS device;
(4) SA is set to the MAC address of the second TDLS device.

Continuing to refer to the third example and FIG. 4, after AP executes step 4, STA2 executes Step 5, sending a TWT Setup frame (second TWT setup response frame) to the AP. In the TWT Setup frame, Request Type=0, TA is set to the MAC address of TDLS device 2, RA is set to the MAC address of the AP, and DA is set to the MAC address of TDLS device 1.

AP executes Step 6, forwarding TWT Setup frame (first TWT setup response frame) to STA1. In the TWT Setup frame, Request Type=0, TA is set to the MAC address of the AP, RA is set to the MAC address of TDLS device 1, and SA is set to the MAC address of TDLS device 2.

In the embodiments of the present disclosure, the second TDLS device receives a first wireless frame, obtains first identification information of the first wireless frame, and determines whether a first R-TWT schedule is used for transmitting low-latency service data between TDLS devices based on the first identification information. For an R-TWT schedule that can be applied between TDLS devices, the TDLS devices can transmit low-latency services directly through the TDLS channel within the SP of the R-TWT schedule without the participation of the AP, thereby further improving the transmission efficiency of low-latency traffic and optimizing the R-TWT mechanism.

Referring to FIG. 7, based on the same principle as the method provided in the embodiment of the present disclosure, an embodiment of the present disclosure further provides an electronic device, the electronic device is an access point (AP), and the electronic device includes:
a determining module 701, configured to determine a first wireless frame; where the first wireless frame includes first identification information, and the first identification information identifies whether a first restricted target wake time (R-TWT) schedule is used for transmitting low-latency service data between tunneled direct link setup (TDLS) devices; and
a sending module 702, configured to send the first wireless frame.

The present disclosure further provides a communication apparatus, which is applied to an access point (AP). The apparatus includes:
a wireless frame determining module, configured to determine a first wireless frame; where the first wireless frame includes first identification information, and the first identification information identifies whether a first restricted target wake time (R-TWT) schedule is used for transmitting low-latency service data between tunneled direct link setup (TDLS) devices; and
a wireless frame sending module, configured to send the first wireless frame.

The apparatus further includes other modules of the electronic device in the aforementioned embodiments, which will not be described in detail herein.

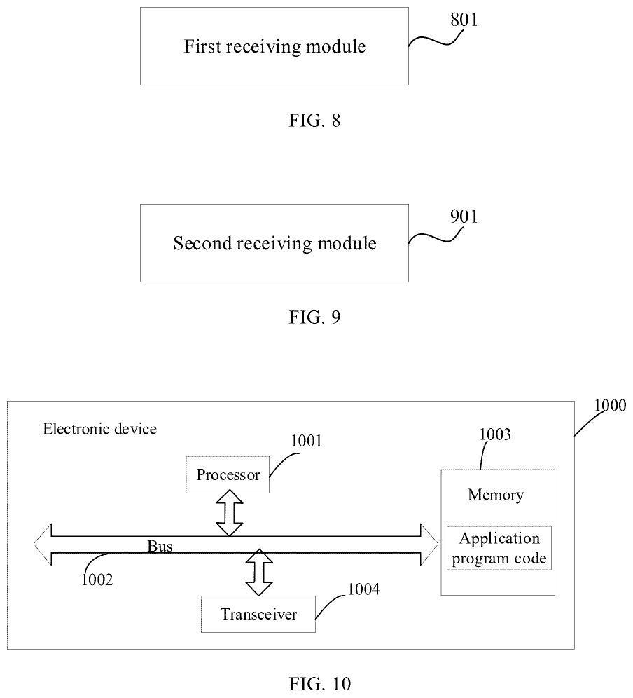

Referring to FIG. 8, based on the same principle as the method provided in the embodiment of the present disclosure, an embodiment of the present disclosure further provides an electronic device, the electronic device is a first TDLS device, and the electronic device includes:

a first receiving module 801, configured to receive a first wireless frame; where the first wireless frame includes first identification information, and the first identification information identifies whether a first restricted target wake time (R-TWT) schedule is used for transmitting low-latency service data between tunneled direct link setup (TDLS) devices.

The present disclosure further provides a communication apparatus, which is applied to a first TDLS device. The apparatus includes:

a first wireless frame receiving module, configured to receive a first wireless frame; where the first wireless frame includes first identification information, and the first identification information identifies whether a first restricted target wake time (R-TWT) schedule is used for transmitting low-latency service data between tunneled direct link setup (TDLS) devices.

The apparatus further includes other modules of the electronic device in the aforementioned embodiments, which will not be described in detail herein.

Referring to FIG. 9, based on the same principle as the method provided in the embodiment of the present disclosure, an embodiment of the present disclosure further provides an electronic device, the electronic device is a second TDLS device, and the electronic device includes:

a second receiving module 901, configured to receive a first wireless frame; where the first wireless frame includes first identification information, and the first identification information identifies whether a first restricted target wake time (R-TWT) schedule is used for transmitting low-latency service data between tunneled direct link setup (TDLS) devices.

The present disclosure further provides a communication apparatus, which is applied to a second TDLS device. The apparatus includes:

a second wireless frame receiving module, configured to receive a first wireless frame; where the first wireless frame includes first identification information, and the first identification information identifies whether a first restricted target wake time (R-TWT) schedule is used for transmitting low-latency service data between tunneled direct link setup (TDLS) devices.

The apparatus further includes other modules of the electronic device in the aforementioned embodiments, which will not be described in detail herein.

In an optional embodiment, an embodiment of the present disclosure further provides an electronic device. As shown in FIG. 10, the electronic device 1000 shown in FIG. 10 may be a server, including: a processor 1001 and a memory 1003. The processor 1001 is connected to the memory 1003, for example, via a bus 1002. In some examples, the electronic device 1000 may further include a transceiver 1004. It should be noted that, in practical applications, the number of transceivers 1004 is not limited to one, and the structure of the electronic device 1000 does not constitute a limitation on the embodiments of the present disclosure.

The processor 1001 may be a central processing unit (CPU), a general-purpose processor, a digital signal processor (DSP), an application specific integrated circuit (ASIC), a field programmable gate array (FPGA), or other programmable logic devices, transistor logic devices, hardware components, or any combination thereof. It can implement or execute various exemplary logical blocks, modules, and circuits described with reference to the disclosure of the present disclosure. The processor 1001 may also be a combination that implements computing functions, such as a combination including one or more microprocessors, a combination of a DSP and a microprocessor, etc.

The bus 1002 may include a path for transmitting information between the above components. The bus 1002 may be a peripheral component interconnect (PCI) bus or an extended industry standard architecture (EISA) bus, or the like. The bus 1002 may be divided into an address bus, a data bus, a control bus, etc. For ease of representation, only one thick line is used in FIG. 10 for indicating the bus, but it does not indicate that there is only one bus or only one type of bus.

The memory 1003 may be a read only memory (ROM) or other types of static storage devices that may store static information and instructions, a random access memory (RAM) or other types of dynamic storage devices that may store information and instructions, or an electrically erasable programmable read only memory (EEPROM), a compact disc read only memory (CD-ROM) or other optical disk storage, optical disc storage (including compact optical disc, laser disc, optical disc, digital versatile optical disc, Blu-ray disc, etc.), a magnetic disk storage medium or other magnetic storage device, or any other medium that may be used to carry or store desired program code in the form of instructions or data structures and may be accessed by a computer, but is not limited thereto.

The memory 1003 is used to store the application program code for executing the solutions of the present disclosure, and the execution is controlled by the processor 1001. The processor 1001 is configured to execute the application program code stored in the memory 1003, so as to implement the contents shown in the foregoing method embodiments.

The electronic device includes, but is not limited to: a mobile terminal such as a mobile phone, a laptop computer, a digital broadcast receiver, a personal digital assistant (PDA), a tablet computer (PAD), a portable multimedia player (PMP), a vehicle-mounted terminal (e.g., a vehicle-mounted navigation terminal), etc., as well a fixed terminal such as a digital TV, a desktop computer, and the like. The electronic device shown in FIG. 10 is merely an example and should not impose any limitation on the functions and scope of use of the embodiments of the present disclosure.

The server provided in the present disclosure may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, CDN, as well as big data and artificial intelligence platforms. The terminal may be a smart phone, a tablet computer, a notebook computer, a desktop computer, a smart speaker, a smart watch, etc., but is not limited thereto. The terminal and the server can be connected directly or indirectly through wired or wireless communication methods, which is not limited in the present disclosure.

An embodiment of the present disclosure provides a computer-readable storage medium on which a computer program is stored, the computer program, when being run on a computer, causes the computer to execute the corresponding contents in the above method embodiments.

It should be understood that, although the steps in the flowcharts of the accompanying drawings are shown in sequence as indicated by the arrows, these steps are not necessarily performed sequentially in the order as indicated by the arrows. There is no strict restriction on the performing order of these steps, and they may be performed in other orders, unless otherwise stated herein. Moreover, at least a part of the steps in the flowcharts of the accompanying drawings may include multiple sub-steps or multiple stages, and these sub-steps or stages are not necessarily completed at the same time, but may be performed at different times, and the performing order thereof is not necessarily sequential, but may be performed in turn or alternately with other steps or at least a part of the sub-steps or stages of other steps.

It should be noted that the computer-readable medium mentioned above in the present disclosure may be a computer-readable signal medium or a computer-readable storage medium or any combination of the two. The computer-readable storage medium may be, for example, but is not limited to, an electrical, magnetic, optical, electromagnetic, infrared, or semiconductor system, apparatus or device, or any combination of the above. More specific examples of the computer-readable storage medium may include, but is not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium containing or storing a program that may be used by or in combination with an instruction execution system, apparatus or device. In the present disclosure, the computer-readable signal medium may include a data signal propagated in a baseband or as part of a carrier wave, which carries computer-readable program code. The propagated data signal may take a variety of forms, including but not limited to electromagnetic signals, optical signals, or any suitable combination of the above. The computer readable signal medium may also be any computer readable medium other than the computer readable storage medium, which may send, propagate or transmit a program for use by or in conjunction with an instruction execution system, apparatus or device. The program code contained on the computer readable medium may be transmitted using any appropriate medium, including but not limited to: wires, optical cables, RF (radio frequency), etc., or any suitable combination of the above.

The aforementioned computer-readable medium may be included in the above-mentioned electronic device; alternatively, it may exist independently without being assembled into the electronic device.

The computer-readable medium carries one or more programs. The one or more programs, when executed by the electronic device, cause the electronic device to execute the method shown in the above embodiments.

According to an aspect of the present disclosure, a computer program product or a computer program is provided, the computer program product or the computer program includes computer instructions, and the computer instructions are stored in a computer-readable storage medium. A processor of a computer device reads the computer instructions from the computer-readable storage medium, and the processor executes the computer instructions, to cause the computer device to perform the methods provided in the above various optional implementations.

The computer program code for performing the operations of the present disclosure may be written in one or more programming languages, or a combination thereof, including object-oriented programming languages, such as Java, Smalltalk, C++, and conventional procedural programming languages, such as “C” language or similar programming languages. The program code may be executed entirely on the user's computer, partially executed on the user's computer, executed as a separate software package, executed partially on the user's computer and partially on a remote computer, or executed entirely on a remote computer or server. In the cases involving a remote computer, the remote computer may be connected to the user's computer through any type of network, including a local area network (LAN) or a wide area network (WAN), or may be connected to an external computer (e.g., via Internet using an Internet service provider).

The flow charts and block diagrams in the accompanying drawings illustrate the possible architectures, functions and operations of the system, method and computer program product according to various embodiments of the present disclosure. In this regard, each of the blocks in the flow charts or block diagrams may represent a module, a program segment or part of code, and the module, the program segment or the part of code contains one or more executable instructions for realizing the specified logical functions. It should also be noted that in some alternative implementations, the functions marked in the blocks may also occur in a sequence different from that marked in the accompanying drawings. For example, two blocks shown in succession may actually be executed substantially in parallel, or they may sometimes be executed in the opposite order, depending on the functions involved. It should also be noted that each block in the block diagrams and/or flow charts, and the combination of the blocks in the block diagrams and/or flow charts may be implemented with a dedicated hardware-based system that performs a specified function or operation, or may be implemented with a combination of dedicated hardware and computer instructions.

The modules involved in the embodiments described in the present disclosure may be implemented in software or in hardware. The names of the modules do not make limitation on the modules themselves in some cases. For example, a module A may also be described as “a module A for performing operation B”.

Those described above are only explanations of preferred embodiments of the present disclosure and the technical principles employed. Those skilled in the art should understand that the scope of disclosure involved in the present disclosure is not limited to the technical solutions formed by the above specific combination of the technical features, but should also cover other technical solutions formed by any combination of the above technical features or their equivalent features without departing from the above disclosed concept, for example, a technical solution formed by replacing the above features with the technical features with similar functions disclosed in the present disclosure (but not limited thereto).

1. A communication method, performed by an access point (AP), and the method comprising:
determining a first wireless frame; wherein the first wireless frame comprises first identification information, and the first identification information identifies whether a first restricted target wake time (R-TWT) schedule is used for transmitting low-latency service data between tunneled direct link setup (TDLS) devices; and
sending the first wireless frame.

2. The communication method according to claim 1, wherein the first wireless frame comprises a TWT element;
the TWT element comprises a broadcast TWT parameter set field; and
the first identification information is comprised in a broadcast TWT information (Broadcast TWT Info) subfield of the broadcast TWT parameter set field.

3. The communication method according to claim 2, wherein the broadcast TWT parameter set field comprises at least one of:
a broadcast TWT recommendation subfield; wherein
the broadcast TWT recommendation subfield is set to a first parameter value, to indicate that a type of the broadcast TWT parameter set field is an R-TWT parameter set;
a trigger identification bit, wherein the trigger identification bit is set to a second parameter value, to indicate that a service period of the first R-TWT schedule does not comprise a trigger frame; or
a restricted TWT traffic information (Restricted TWT Traffic Info) subfield; wherein
the Restricted TWT Traffic Info subfield comprises a TDLS traffic identifier bitmap valid (TDLS TID Bitmap Valid) identification bit; and
the TDLS TID Bitmap Valid identification bit is set to a third parameter value, to indicate that the Restricted TWT Traffic Info subfield comprises a TWT TDLS traffic identifier bitmap (TWT TDLS TID Bitmap).

4. (canceled)

5. (canceled)

6. The communication method according to claim 2, wherein the first identification information comprises a restricted TWT schedule information subfield; and
the restricted TWT schedule information subfield is set to a fourth parameter value, to indicate that the first R-TWT schedule is used for transmitting the low-latency service data between the TDLS devices.

7. (canceled)

8. The communication method according to claim 1, wherein after sending the first wireless frame, the method comprises:
receiving a first TWT setup request frame sent by a first TDLS device; and
in response to the first TWT setup request frame, sending a second TWT setup request frame to a second TDLS device;
wherein the first TWT setup request frame and the second TWT setup request frame request: setting up the first R-TWT schedule on a TDLS channel between the first TDLS device and the second TDLS device.

9. The communication method according to claim 8, wherein after sending the second TWT setup request frame to the second TDLS device, the method comprises:
receiving a second TWT setup response frame sent by the second TDLS device; and
in response to the second TWT setup response frame, sending a first TWT setup response frame to the first TDLS device.

10. A communication method, performed by a first TDLS device, and the method comprising:
receiving a first wireless frame; wherein the first wireless frame comprises first identification information, and the first identification information identifies whether a first restricted target wake time (R-TWT) schedule is used for transmitting low-latency service data between tunneled direct link setup (TDLS) devices.

11. The communication method according to claim 10, wherein the first wireless frame comprises a TWT element; and
the TWT element comprises a broadcast TWT parameter set field; and the first identification information is comprised in a broadcast TWT information (Broadcast TWT Info) subfield of the broadcast TWT parameter set field.

12. The communication method according to claim 11, wherein the broadcast TWT parameter set field comprises at least one of:
a broadcast TWT recommendation subfield; wherein
the broadcast TWT recommendation subfield is set to a first parameter value, to indicate that a type of the broadcast TWT parameter set field is an R-TWT parameter set;
a trigger identification bit, wherein the trigger identification bit is set to a second parameter value, to indicate that a service period of the first R-TWT schedule does not comprise a trigger frame; or
a restricted TWT traffic information (Restricted TWT Traffic Info) subfield; wherein
the Restricted TWT Traffic Info subfield comprises a TDLS traffic identifier bitmap valid (TDLS TID Bitmap Valid) identification bit; and
the TDLS TID Bitmap Valid identification bit is set to a third parameter value, to indicate that the Restricted TWT Traffic Info subfield comprises a TWT TDLS service identifier bitmap (TWT TDLS TID Bitmap).

13. (canceled)

14. (canceled)

15. The communication method according to claim 11, wherein the first identification information comprises a restricted TWT schedule information subfield; and
the restricted TWT schedule information subfield is set to a fourth parameter value, to indicate that the first R-TWT schedule is used for transmitting the low-latency service data between the TDLS devices.

16. (canceled)

17. The communication method according to claim 10, wherein after receiving the first wireless frame, the method comprises:
sending a first TWT setup request frame to an access point (AP), which instructs the AP to send a second TWT setup request frame to a second TDLS device in response to the first TWT setup request frame;
wherein the first TWT setup request frame and the second TWT setup request frame request: setting up the first R-TWT schedule on a TDLS channel between the first TDLS device and the second TDLS device.

18. The communication method according to claim 17, wherein after sending the first TWT setup request frame to the access point (AP), the method comprises:
receiving a first TWT setup response frame sent by the AP; wherein the second first TWT setup response frame is sent by the AP in response to the second TWT setup response frame sent by the second TDLS device.

19. A communication method, performed by a second TDLS device, and the method comprising:
receiving a first wireless frame; wherein the first wireless frame comprises first identification information, and the first identification information identifies whether a first restricted target wake time (R-TWT) schedule is used for transmitting low-latency service data between tunneled direct link setup (TDLS) devices.

20. The communication method according to claim 19, wherein the first wireless frame comprises a TWT element; and
the TWT element comprises a broadcast TWT parameter set field; and the first identification information is comprised in a broadcast TWT information (Broadcast TWT Info) subfield of the broadcast TWT parameter set field.

21. The communication method according to claim 20, wherein the broadcast TWT parameter set field comprises at least one of:
a broadcast TWT recommendation subfield; wherein
the broadcast TWT recommendation subfield is set to a first parameter value, to indicate that a type of the broadcast TWT parameter set field is an R-TWT parameter set;
a trigger identification bit, wherein the trigger identification bit is set to a second parameter value, to indicate that a service period of the first R-TWT schedule does not comprise a trigger frame; or
a restricted TWT traffic information (Restricted TWT Traffic Info) subfield; wherein
the Restricted TWT Traffic Info subfield comprises a TDLS traffic identifier bitmap valid (TDLS TID Bitmap Valid) identification bit; and
the TDLS TID Bitmap Valid identification bit is set to a third parameter value, to indicate that the Restricted TWT Traffic Info subfield comprises a TWT TDLS traffic identifier bitmap (TWT TDLS TID Bitmap).

22. (canceled)

23. (canceled)

24. The communication method according to claim 20, wherein the first identification information comprises a restricted TWT schedule information subfield; and
the restricted TWT schedule information subfield is set to a fourth parameter value, to indicate that the first R-TWT schedule is used for transmitting the low-latency service data between the TDLS devices.

25. (canceled)

26. The communication method according to claim 19, wherein after receiving the first wireless frame, the method comprises:
receiving a second TWT setup request frame sent by an access point (AP);
wherein the second TWT setup request frame is sent by the AP in response to a first TWT setup request frame sent by a first TDLS device;
wherein the first TWT setup request frame and the second TWT setup request frame request: setting up the first R-TWT schedule on a TDLS channel between the first TDLS device and the second TDLS device.

27. The communication method according to claim 26, wherein after receiving the second TWT setup request frame sent by the access point (AP), the method comprises:
sending a second TWT setup response frame to the AP, which instructs the AP to send a first TWT setup response frame to the first TDLS device in response to the second TWT setup response frame.

28.-30. (canceled)

31. An electronic device, comprising a memory, a processor, and a computer program stored in the memory and executable on the processor, wherein the processor, when executing the program, implements the method according to claim 1.

32. A non-transitory computer-readable storage medium, wherein a computer program is stored on the computer-readable storage medium, and the computer program, when executed by a processor, implements the method according to claim 1.
